(19) United States
(12) Patent Application Publication
(10) Pub. No.: US 2023/0075749 A1
(43) Pub. Date: Mar. 9, 2023

(54) ZINC BASED RECHARGEABLE REDOX STATIC ENERGY STORAGE DEVICE

(71) Applicants: Offgrid Energy Labs Private Limited, New Delhi (IN); Offgrid Energy Labs Inc., San Francisco, CA (US)

(72) Inventors: Brindan Tulachan, Kanpur (IN); Aasiya Bano Shaikh, Nashik (IN); Sumanta Chakrabarty, West Bengal (IN)

(21) Appl. No.: 17/801,208

(22) PCT Filed: Jun. 21, 2021
(86) PCT No.: PCT/IN2021/050599

§ 371 Date: Aug. 19, 2022

(30) Foreign Application Priority Data
Jun. 22, 2020 (IN) 202011026184

(51) Int. Cl. H01M 8/18; H01M 4/86; H01M 4/96; H01M 8/0206; H01M 8/0213; H01M 8/0239; H01M 8/0215

(52) U.S. Cl. CPC H01M 8/188; H01M 4/8668; H01M 4/96; H01M 8/0206; H01M 8/0213; H01M 8/0239; H01M 8/0215; H01M 2004/8689; H01M 2004/8684; H01M 2300/0028

(57) ABSTRACT

A zinc based rechargeable redox static energy storage device includes a cathode including a carbon material—binder composition and an anode including carbon material—Zinc material—binder composition both infused with an eutectic electrolyte comprising one or more inorganic transition metal salt(s) of zinc, one or more Metal hydroxide(s) and eutectic solvent comprising derivative(s) of methanesulfonic acid, ammonium salt(s) and hydrogen bond donor(s); a separator separating the cathode and anode so that the ion exchange carries in between the cathode and anode through ionic permeability; and current collector connected with the cathode and anode respectively.

### CROSS REFERENCE TO RELATED APPLICATIONS

The present application is a national stage of International Application PCT/IN2021/050599, filed Jun. 21, 2021, which claims priority benefit of India Pat. Application Ser. No. 202011026184, filed Jun. 22, 2020, both of which are hereby incorporated herein by reference in the entireties.

### FIELD OF INVENTION

The present invention relates to the rechargeable redox energy storage device and more particularly to zinc-based rechargeable redox static energy storage device having high energy efficiency, long cyclic life, 100% DOD and high rate charging and discharging capability.

### BACKGROUND OF THE INVENTION

With continuing depletion of fossil fuels and increasing environmental problems with their use, technology is shifting towards green and sustainable alternatives for energy generation, utilization and storage. Use of the green and renewable energy resources like solar, wind, geothermal, tidal, etc. for power generation is now becoming a promising solution for fulfilling ever-growing energy needs for more devices, technology and transportation. However, efficiently exploiting such renewable energy sources for energy needs has many critical challenges as suggested from hurdles of intermittent nature of these resources and lack of apt facilities to store their energy in suitable energy form. Converting energy from renewable sources into electrical energy and saving the same for later use is the most convenient and effective way of exploiting them.

Various energy storage devices like batteries etc. are being used since long for electricity storage purposes and have been improved from time to time. Among existing rechargeable energy storage devices, lithium-ion energy storage devices dominate the rechargeable energy storage devices market with its application including electronic gadgets (mobile phones, laptops and smartwatches etc.), automobile sector owing to its high energy density. However, lithium-ion batteries have their shortcomings, including supply chain issues, high cost of the materials and assembly line, environmental hazard in the disposal and most important is the safety of the end product. Review reports titled as “Economic and environmental characterization of an evolving Li-ion battery waste stream” by Xue Wang et al. published by Journal of Environmental Management, http://dx.doi.org/10.1016/j.jenvman.2014.01.021 and “Emerging non-lithium ion batteries” by Yanrong Wang et al. published by Energy Storage Materials journal, http://dx.doi.org/10.1016/j.ensm.2016.04.001 talks about various shortcomings and environmental hazards inherent with lithium ion energy storage devices.

The other energy storage device chemistries like lead-acid batteries suffer from poor performance with 300-500 cycle life and 70% coulombic efficiency, which reaches a maximum of 90% in the special design cases. Review reports like “An Overview of Lithium-ion Batteries for Electric Vehicles by Xiaopeng Chen, et al. published by IEEE, DOI:10.1109/ASSCC.2012.6523269”; “Energy analysis of batteries in photovoltaic systems. Part I: Performance and energy requirements by Carl Johan Rydh et al. published by Energy Conservation & Management, doi:10.1016/j.enconman.2004.10.003” and “Battery Technologies for Grid-Level Large-Scale Electrical Energy Storage by Xiayue Fan, https://doi.org/10.1007/s12209-019-00231-w” though disclose various other energy storage device chemistries like lead-acid batteries however then still present with various shortcomings which needs answers.

The utilization of lead and sulfuric acid is also an environmental concern (refer review article “Study on the environmental risk assessment of lead-acid batteries” by Jing Zhang et al. published Procedia Environmental Sciences, doi: 10.1016/j.proenv.2016.02.103). Nickel metal hydride batteries suffer from low energy densities, high self-discharge rates, recycling issues and poor performance at elevated temperatures. The main concern associated with the nickel-cadmium batteries is the toxicity of the cadmium along with low energy density and fast discharge rate. (Refer “Nickel-based batteries: materials and chemistry” by P-J. TSAI et al., DOI: 10.1533/9780857097378.3.309)

Recently other rechargeable energy storage devices chemistries (Zn2+, Ca2+, Mg2+ and Na+) which offer safe and promising output have acquired the attention of the researchers. Among these energy storage devices alternatives, zinc chemistry is very compelling owing to its abundance, low cost, high chemical and physical stability at the room temperature and elevated temperature conditions, recyclability, eco-friendliness, high safety associated with the utilization. Beside this zinc offers high anode capacity, non-toxic nature and low redox potential with respect to the standard hydrogen electrode (−0.76V). Up until now, zinc has been utilized in many energy storage devices chemistries like zinc-air batteries, zinc ion batteries, zinc-manganese dioxide batteries, zinc-bromine and nickel-zinc batteries. Out of these zinc-based batteries, primary zinc-manganese dioxide batteries are popular due to their low cost and high energy density. Report titled as “Recent Advances in Aqueous Zinc-Ion Batteries” by Guozhao Fang et al. has attempted to mention various recent developments in Zinc-ion based batteries technologies, however there are still various shortcomings remains which requires answers.

The performance of the rechargeable zinc energy storage devices is dependent on the chemical nature of the salts, their concentration being used, electrolytes and the materials used as electrodes. Ionic liquids which usually composed of bulky asymmetric organic cations and organic/inorganic anions are another kinds of solvents which are being explored for possible solutions to the limitations present with the existing electrolytes used in zinc-based rechargeable energy storage devices. Even eutectic solvent-based electrolytes popularly known as Deep Eutectic Solvent (DES) based electrolytes are also being experimented upon as a possible replacement for existing electrolytes. However, the limitations present within ionic liquids and even eutectic based solvent electrolytes limit their utilization as electrolytes for zinc-based rechargeable energy storage devices. The morphology of zinc deposits depends upon the constituent ions of the ionic liquids. Problems like cost, viscosity, toxicity, etc. which limits the utilization of the existing electrolytes as a suitable electrolyte. The technology regarding usage of ionic liquids or eutectic solvent-based electrolytes as the electrolytes for zinc-based rechargeable energy storage devices is at a very nascent stage, and there is much to be explored.

Electrodes have a great impact on the efficiency and life of the energy storage devices. Further, the surface area of electrodes available to reaction plays a vital role in the performance of the energy storage devices. Hence, more suitable electrode materials with high surface area, physical, chemical & structural stability is always desired, which increases overall performance and life of the energy storage devices.

Many efforts have been made in past to obtain efficient secondary zinc manganese dioxide batteries. However, the secondary zinc energy storage devices have their issues related to zinc dendrite formation, reaction irreversibility leading to poor performance, lower capacity and limited cyclic life. Hence although zinc energy storage devices offer recyclability, cost-effective options and ease of manufacturing (different composition shapes, sizes) and alternative solutions for large scale off-grid energy storage applications and mobility substitute for public transportation over lithium-ion or lead-acid energy storage devices it cannot achieve the desired outcome with the existing chemistries which are being utilized in zinc-based energy storage devices.

Further, most of the existing Zinc based redox energy storage devices works on redox flow battery technology. The electrolyte for energy storage device requires to be stored in storage tanks and are pumped so that very large volumes of the electrolytes can be circulated through the device on separate sides of a membrane acting as separator. The energy storage device when charged chemical potential energy generated is stored in the electrolyte storage tank. The existing, Zn based flow energy storage device have problems with dendrite growth particularly as operating current density is increased during charging (deposition).

Patent application US 20180277864 A1 though claims to solve to an extent problem with dendrite growth the circulation of liquid electrolytes is somewhat cumbersome and does restrict the use of zinc redox flow batteries in mobile applications, effectively confining them to large fixed installations. The use large equipment and requirement of storing electrolyte in storage tanks and pumping it during charging/discharging makes the whole arrangement very costly.

Due to limitations present with the existing Zinc redox flow energy storage devices, attempts have been made to develop zinc redox battery with non-flow electrolyte. U.S. Pat. No. 5,591,538A discloses a Zinc-Bromine redox battery with non-flow electrolyte, however, its application is very limited. Bromine is known for its inherent highly corrosive nature which limits its widescale application as redox couple. The corrosive nature leads to poor energy efficiency of the battery and also require special leak proof arrangement to prevent any escape of bromine in any form outside the battery.

There is need for exploring new possibilities as well as scope of improvement in the existing technology regarding the materials used, designs involved in the manufacturing the device to overcome the problems present in the existing zinc based rechargeable redox static energy storage devices and may increase the overall performance of the energy storage device and decreases manufacturing costs.

### SUMMARY OF THE INVENTION

The present invention proposes a zinc based rechargeable redox static energy storage device which has answers to the limitations of the existing zinc based rechargeable redox static energy storage devices and has desired improved characteristics as mentioned above over the existing ones.

The zinc based rechargeable redox static energy storage device according to present invention comprising a cathode pre-infused with an eutectic electrolyte in ratio ranging between 0.5-1.5:2-5; an anode pre-infused with the eutectic electrolyte in ratio ranging between 0.5-1.5:2-5; wherein the cathode is connected to a current collector; wherein anode is connected to a current collector; a separator separating the cathode and anode so that the ion exchange carries in between the cathode and anode through ionic permeability.

The cathode comprises a carbon material—binder composition in weight ratio maintained between 80-99.9:0.1-20; the anode comprises a carbon material—Zinc material—binder composition, in weight ratio maintained between 80-90:10-15.9:0.1-10; wherein the carbon material is selected alone or in combination from a group consisting of conductive carbon black, graphite, carbon particles, carbon nanoparticles, woven or non-woven carbon cloth, carbon felt, carbon paper, carbon rod, and combination thereof; wherein the binder is selected from a group consisting of PTFE, PVDF, SBR, CMC, PVA; wherein the zinc material is selected from a group consisting of Zinc powder, Zinc Dust, Zinc foil; wherein the eutectic electrolyte comprises one or more inorganic transition metal salt(s) of zinc selected from a group consisting of Zinc Chloride, Zinc Acetate, Zinc Methanesulfonate, Zinc Sulphate, Zinc triflate; one or more salt(s) of metal(s) selected from a group consisting of manganese, nickel, titanium and copper metal with sulphate anions, methane sulfonate anions, halides anions including chloride, bromide, organic salts of transition metal ions with anions like acetate, oxalates, formates, phosphinates, lactate, malate, citrate, benzoate, ascorbate; one or more Metal hydroxide(s) selected from a group consisting of sodium hydroxide, potassium hydroxide, aluminum hydroxide, zinc hydroxide, calcium hydroxide, cesium hydroxide, magnesium hydroxide, iron hydroxide; wherein one or more inorganic transition metal salt(s) of zinc, one or more salt(s) of metal(s) and one or more Metal hydroxide(s) in molar concentration range 0.1-3:0.1-3:0.05-1 are mixed to a eutectic solvent comprising one or more derivative(s) of methanesulfonic acid selected from its salts with various metal ions selected from a group consisting of manganese, zinc, cerium, nickel, titanium, copper, sodium, potassium and calcium; one or more ammonium salt(s) having general formula NH₄X, where X can be selected from a group consisting of chloride, methanesulfonate, acetate, sulphate, triflate, trimethanesulfonate; one or more hydrogen bond donor(s) selected from a group consisting of urea, thiourea, glycerol, oxalic acid, acetic acid, ethylene glycol, acetamide, benzamide, adipic acid, benzoic acid, citric acid; wherein the molar ratio of derivative(s) of methanesulfonic acid, ammonium salt(s) and hydrogen bond donor(s) is in the range 0.5-3: 2-7:8-13.

The current collector is selected from a group consisting of titanium, and carbon material; and the current collector is selected from a group consisting of titanium, carbon material and zinc material.

The separator used is selected from material selected from a group consisting of micro porous PVC, micro porous poly propylene, absorptive glass matt, and cellulose filter paper. The thickness ratio of the anode and cathode ranges in between 2-10:1-5. The zinc based rechargeable redox static energy storage device as disclosed in the present invention has C rating ranging between 0.2-5 and cycle life ranging between 3000 to 10000.

These and other objects, advantages and features of the invention will become apparent upon review of the following specification in conjunction with the drawings.

### BRIEF DESCRIPTION OF DRAWINGS

FIG. 1 is an exploded view of one embodiment according to present invention;

FIG. 2 shows a scan rate of 5 mV/s, the cyclic voltammetry curve of test device. At a possible range of 1-2.2V, a pair of well-defined peaks could be seen. The ratio of oxidation and reduction is ˜1 indicating highly reversible reaction;

FIG. 3 shows XRD pattern of cathode of test devices A and B at 100% and 0% state of charge respectively after removing carbon peaks. At 0% SOC there are no obvious peaks except for titanium current collector peaks while at 100% SOC there are Manganese Dioxide peaks;

FIG. 4 shows Galvanostatic charge-discharge profile of test device. Two voltage plateaus at around 1.5 V and 1.4 V represents charging and discharging process, respectively;

FIG. 5 shows cycling of the test device at a constant current, the test device's charge-discharge behavior. Both profiles show a steady increase in discharge capacity as the cycle life increases;

FIG. 6 shows Galvanostatic charge-discharge profile of test device at constant voltage 1.7 V charge—constant current discharge (CV-CC) condition;

FIG. 7 shows Galvanostatic charge-discharge profile of test device at different current rate, i.e., C/7, C/4, 1C, 5C. High columbic efficiency and low polarization is observed throughout the current range;

FIG. 8 shows the cycle performance—Coulombic efficiency and discharge capacity of prepared test device in different temperature of 15 C (Lower Dot) and 30 C (Upper Dot);

FIG. 9 shows Cycle life, Coulombic efficiency of the Zinc Redox battery test device at 3C rate. The Zinc Redox battery exhibits excellent cycling stability. Close to 95% of the maximum discharge capacity is maintained after prolong cycling; and

FIG. 10 shows Cycle life, Coulombic efficiency of the Zinc Redox battery test device at 5C rate. The Zinc Redox battery exhibits excellent cycling stability, even at high rates.

### DETAILED DESCRIPTION OF THE DRAWINGS

The present invention discloses a zinc based rechargeable redox static energy storage device (1) which_works on redox principle. The components used in the preparation of the device (1) are eco-friendly, non-toxic and non-flammable. The device, according to the present invention, is recyclable.

### I. Definitions

For purposes of interpreting the specification and appended claims, the following terms shall be given the meaning set forth below:

The term “redox” shall refer to chemical reaction in which oxidation and reduction changes can occur by losing and gaining electrons for example Mn²⁺ ion is oxidized to manganese dioxide, Manganese dioxide is reduced to Mn²⁺ ion.

The term “static energy storage device” shall mean an energy storage device with physically non-flowing or non-moving electrolyte or cathode or anode materials.

The term “solvent” shall refer to a liquid medium capable of dissolving other substance(s). The “eutectic electrolyte” shall refer to an electrolyte solution that comprises ions, but does not use water as the solvent. It generally contains eutectic solvent and ions, atoms or molecules that have lost or gained electrons, and is electrically conductive.

The term “carbon material” shall refer to carbon-containing material or carbon-containing compound having at least 98% carbon. Examples includes but not limited to conductive carbon black, carbon particles, carbon nanoparticles, woven or non-woven carbon cloth, carbon felt, carbon paper, carbon rod, and combination thereof.

The binder shall refer to a substance that holds two or more materials together. Examples includes but not limited to PTFE, PVDF, SBR, CMC, PVA.

The zinc material shall refer to various form of zinc metal. Examples includes but not limited to Zinc powder, Zinc Dust, Zinc foil.

The term “separator” shall refer to a permeable membrane between anode and cathode and allows ion exchange between the electrodes without short circuiting the device. Examples includes but not limited to micro porous PVC, micro porous poly propylene, absorptive glass matt, cellulose filter paper.

The term “current collectors” shall refer to material used for carrying out conduction of electron through electrodes.

When referring to the concentration of components or ingredients for electrolytes, Mols shall be based on the total volume of the electrolyte.

### II. Description

Reference is hereby made in detail to various embodiments according to present invention, examples of which are illustrated in the accompanying drawings and described below. It will be understood that invention according to present description is not intended to be limited to those exemplary embodiments. The present invention is intended to cover various alternatives, modifications, equivalents and other embodiments, which may be included within the spirit and scope of the invention as defined by the claims.

The zinc based rechargeable redox static energy storage device according to present invention comprising a cathode pre-infused with an eutectic electrolyte in ratio ranging between 0.5-1.5:2-5; an anode pre-infused with the eutectic electrolyte in ratio ranging between 0.5-1.5:2-5; wherein the cathode is connected to a current collector; wherein anode is connected to a current collector; a separator separating the cathode and anode so that the ion exchange carries in between the cathode and anode through ionic permeability. In formation of cathode (2), carbon material is homogenously mixed with the binder in the weight ratio ranging between 80-99.9:0.1-20. The carbon material—binder composition is infused with eutectic electrolyte in wt. ratio ranging between 0.5-1.5:2-5 forming a clay-kind paste. The paste is shaped to be used as cathode (2). The cathode (2) so prepared is termed as “cathode pre-infused with the eutectic electrolyte”.

In formation of anode (3), carbon material is homogenously mixed with Zinc material and the binder in weight ratio ranging between 80-90:10-15.9:0.1-10. The carbon material—Zinc material—binder composition is infused with eutectic electrolyte in wt. ratio ranging between 0.5-1.5:2-5 forming a clay-kind paste. Alternatively, anode (3) is formed by homogenously mixing carbon material with the binder. The carbon material—binder composition is infused with eutectic electrolyte in wt. ratio ranging between 0.5-1.5:2-5 forming a clay-kind paste. Instead of homogenously mixing zinc material to carbon material—binder composition, it is used in from of zinc foil in proportionate weight ratio maintaining carbon material—Zinc material—binder weight ratio ranging between 80-90:10-15.9:0.1-10. The paste is shaped with zinc foil ranging to be used as anode (3). carbon material—Zinc material—binder composition is shaped to be used as anode (3). The anode (3) so prepared is termed as “anode pre-infused with the eutectic electrolyte”.

The carbon material used is selected from a group consisting of conductive carbon black, carbon particles, carbon nanoparticles, woven or non-woven carbon cloth, carbon felt, carbon paper, carbon rod, and combination thereof.

The binder used is selected from a group consisting of PTFE, PVDF, SBR, CMC, PVA.

The zinc material used is selected from a group consisting of Zinc powder, Zinc Dust, Zinc foil.

The eutectic electrolyte comprises one or more inorganic transition metal salt(s) of zinc selected from a group consisting of Zinc Chloride, Zinc Acetate, Zinc Methanesulfonate, Zinc Sulphate, Zinc triflate; one or more salt(s) of metal(s) selected from a group consisting of manganese, nickel titanium and copper metal with sulphate anions, methane sulfonate anions, halides anions including chloride, bromide, organic salts of transition metal ions with anions like acetate, oxalates, formates, phosphinates, lactate, malate, citrate, benzoate, ascorbate; one or more Metal hydroxide(s) selected from a group consisting of sodium hydroxide, potassium hydroxide, aluminum hydroxide, zinc hydroxide, calcium hydroxide, cesium hydroxide, magnesium hydroxide, iron hydroxide; wherein one or more inorganic transition metal salt(s) of zinc, one or more salt(s) of metal(s) and one or more Metal hydroxide(s) in molar concentration range 0.1-3:0.1-3:0.05-1 are mixed to a eutectic solvent comprising one or more derivative(s) of methanesulfonic acid selected from its salts with various metal ions selected from group consisting of manganese, zinc, cerium, nickel, titanium, copper, sodium, potassium and calcium; one or more ammonium salt(s) having general formula NH₄X, where X can be selected from a group chloride, methanesulfonate, acetate, sulphate, triflate, trimethanesulfonate; one or more hydrogen bond donor(s) selected from a group consisting of urea, thiourea, glycerol, oxalic acid, acetic acid, ethylene glycol, acetamide, benzamide, adipic acid, benzoic acid, citric acid; wherein the molar ratio of derivative(s) of methane sulfonic acid, ammonium salt(s) and hydrogen bond donor(s) is in the range 0.5-3: 2-7:8-13.

In order to prepare the eutectic solvent one or more derivative(s) of methanesulfonic acid selected from its salts with various metal ions selected from a group consisting of manganese, zinc, cerium, nickel, titanium, copper, sodium, potassium and calcium; one or more ammonium salt(s) having general formula NH₄X, where X can be selected from a group consisting of chloride, methanesulfonate, acetate, sulphate, triflate, trimethanesulfonate; one or more hydrogen bond donor(s) selected from a group consisting of urea, thiourea, glycerol, oxalic acid, acetic acid, ethylene glycol, acetamide, benzamide, adipic acid, benzoic acid, citric acid; wherein the molar ratio of derivative(s) of methanesulfonic acid, ammonium salt(s) and hydrogen bond donor(s) in the range 0.5-3: 2-7:8-13 are mixed. Upon proper mixing, the mixture starts converting into a liquid eutectic solvent at ambient temperature and pressure. To ensure the proper mixing of the components and to speed up the process, this mixture may be uniformly heated at a temperature up to 60° C. One or more inorganic transition metal salt(s) of zinc selected from a group consisting of Zinc Chloride, Zinc Acetate, Zinc Methanesulfonate, Zinc Sulphate, Zinc triflate; one or more salt(s) of metal(s) selected from a group consisting of manganese, nickel, titanium and copper metal with sulphate anions, methane sulfonate anions, halides anions including chloride, bromide, organic salts of transition metal ions with anions like acetate, oxalates, formates, phosphinates, lactate, malate, citrate, benzoate, ascorbate; one or more Metal hydroxide(s) selected from a group consisting of sodium hydroxide, potassium hydroxide, aluminum hydroxide, zinc hydroxide, calcium hydroxide, cesium hydroxide, magnesium hydroxide, iron hydroxide; wherein one or more inorganic transition metal salt(s) of zinc, one or more salt(s) of metal(s) and one or more Metal hydroxide(s) in molar concentration range 0.1-3:0.1-3:0.05-1 are added to the eutectic solvent and are continuously mixed until they are completely dissolved in the eutectic solvent resulting into eutectic electrolyte.

For assembling a zinc based rechargeable redox static energy storage device (1) according to the present invention, the cathode (2) pre-infused with eutectic electrolyte and the anode (3) pre-infused with eutectic electrolyte are arranged with a separator between them which allows ion exchange between cathode (2) and anode (3). The cathode (2) is connected with a current collector (5) selected from a group consisting of titanium and carbon material. The anode (2) is connected with a current collector (6) selected from a group consisting of titanium, carbon material, zinc material.

The thickness ratio of the cathode (2) versus anode (3) ranges between 2-10:1-5.

The separator (4) used is selected from a group consisting of micro porous PVC, micro porous poly propylene, absorptive glass matt, cellulose filter paper.

The current collector (5) is selected from a group consisting of titanium and carbon material, wherein carbon material wherein carbon material is selected from the group consisting graphite, woven or non-woven carbon cloth, carbon felt, carbon paper, carbon rod.

The redox reaction on the cathode side (2) involves manganese ionic species dissolved in the eutectic electrolyte which electro deposits manganese oxide during charging and dissolves back to eutectic electrolyte during discharging.

The redox reaction on the anode side (3) involves Zinc ionic species dissolved in eutectic electrolyte which electro deposits zinc metal during charging and dissolves back to eutectic electrolyte during discharging.

The cathode (2) pre-infused with eutectic electrolyte and the anode (3) pre-infused with eutectic electrolyte omits requirement of storing electrolyte in storage tanks and pumping them into the device (1). Further, pre-infusing the electrodes (2, 3) with electrolyte in the device (1) according to the present invention omits the requirement of keeping the device (1) idle, which earlier was a requirement for uniform soaking of electrolyte in electrodes in the existing devices. The high efficiency, long cyclic life, 100% depth of discharge (“DOD”) and high rate charging and discharging capability, simple yet effective and economical design and use of nontoxic and non-corrosive constituents ensures safe and widescale applications of the device according to the present invention.

In a preferred embodiment according to the present invention, complete device (1) is prepared in the following manner

Preparation of Eutectic Electrolyte:

Eutectic electrolyte is prepared by combining 2 moles of calcium methanesulfonate, 5 moles of ammonium chloride, and 10 moles of ethylene glycol in a rotary round-bottom flask at 60 C in an oil bath and rotating it for about 45 minutes obtain a clear, colorless eutectic solvent. Then the eutectic solvent is transferred to a glass bottle. The bottle is placed on a magnetic stirrer plate. 1 mole of Manganese Chloride, 1 mole of Zinc Chloride are then weighed and slowly added to the eutectic solvent under continued stirring. The mixture is stirred until all the salts is dissolved. Then 0.4 Zinc Hydroxide is added to the mixture and is stirred again resulting into slight pinkish transparent eutectic electrolyte. The eutectic electrolyte is then removed from the stirrer plate and stored in a glass bottle.

Zinc Based Rechargeable Redox Static Energy Storage Device (1) Preparation:

Carbon material—binder composition is prepared by uniform mixing of conductive acetylene black and a binder solution. In the carbon material—binder composition, the weight ratio of carbon to binder is maintained at 99.1:0.9. Liquid dispersed Polytetrafluoroethylene (PTFE), a non-sticky fluoropolymer, is used as a binder. Diluted Isopropyl alcohol (20 vol %) is used as a solvent for the PTFE, binder. Conductive carbon, AB 50 from Polimaxx, is mixed with the PTFE solution to form a homogeneous clay-like paste in a planetary mixer for 1 hour. Then the clay like paste is laid over the tray and spread across it. This is then followed by vacuum dried at 60° C. for overnight to evaporate the solvent. The carbon material—binder composition is infused with the eutectic electrolyte mentioned above in 1:3 weight ratios. Mixing is done in end mill roll for 30 mins resulting into clay like paste. The paste is thereafter used to prepare sheets of controlled thickness by repeatedly rolling using TOB-SG-100L lab roll press machine. For the cathode (2) thickness of sheet is maintained at 1 mm and for the anode (3) the thickness is 0.5 mm A thin zinc foil having a thickness of 30 microns is placed over sheet of thickness 0.5 mm forming anode. Individual titanium foil is connected to each of the electrodes (2, 3) and served as a current collector for both electrodes (2, 3).

The electrodes (2, 3) with current collectors are assembled with Celgard 3501, a polypropylene-based microporous membrane, used as the separator (4) between them.

The resultant embodiment is termed as “Test device (1)”

FIG. 1 is exploded view of preferred embodiment that is termed as “test device (1)”

### EXPERIMENTATION

Testing:

Test device (1) is prepared as above and tested using cyclic voltammetry (CV) on a Biologic VPM3 electrochemical workstation at a scanning rate of 5 mV s-1.

Constant Current Charge and Constant Current Discharge procedures are used to test the test device (1). The test device (1) is also tested at different C rate of C/7, C/4, 1C, 5C.

The test device (1) is tested at voltages ranging from 0.5 to 1.9 volts. The test device (1) is tested using a Neware battery cycler. When the test device (1) is charged, soluble Manganese ions in the eutectic electrolyte diffuse to the cathode and deposit on the various forms of conductive carbon black as solid Manganese oxide, while Zinc ions are electrodeposited on the carbon side of anode. The homogeneous layer of as-deposited Manganese oxide on the cathode is dissolved back to soluble Manganese ions in the eutectic electrolyte during battery discharge, and the as-deposited Zinc on the anode is dissolved back to Zinc ions in the eutectic electrolyte.

Experiment 1

Test device (1)'s cyclic voltammograms is obtained to determine reversibility and stability as a possible use case for Zinc redox batteries. Test device (1) CVs of a device from 1 V to 2.2 V at a scan rate of 5 mV/s for 1000 cycles. These results reveal that the eutectic electrolyte has a mainly faradaic reaction and are compatible with galvanic charge discharge patterns.

The above approach is used to prepare test device (1), which are then tested utilizing constant current procedures.

For Manganese Oxide deposition and dissolution, the CV curve of the test device (1) shows a comparable oxidation and reduction peak. At a potential range of 0.9-2.2 V, a pair of well-defined peaks can be seen. The electrochemical deposition of Manganese Oxide from the soluble eutectic electrolyte is assigned to the oxidation peak at 1.7V, whereas the dissolution of Manganese Oxide to Mn²⁺ Ions is attributed to the reduction peak at 1.35V. The oxidation-to-reduction ratio is 1, indicating that the process is highly reversible.

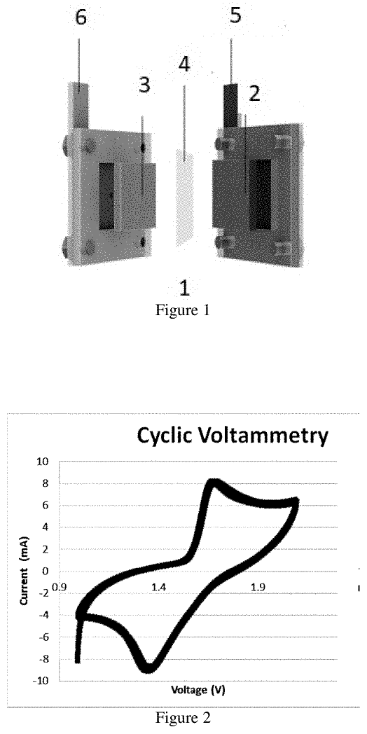

FIG. 2 shows a scan rate of 5 mV/s, the cyclic voltammetry curve of a test-device zinc-based redox battery. At a possible range of 1-2.2V, a pair of well-defined peaks could be seen. The ratio of oxidation and reduction is ˜1 indicating highly reversible reaction.

Experiment 2

To determine the crystalline structure of the electrodes at 0% state of charge and at 100% state of charge (SOC) is identified by Xray diffraction (XRD, PANalytical) with Cu Kα radiation.

Two identical test devices A and B are prepared using the above method and both are fully charged.

Cathode of test device A is removed from device and is separately tested which is considered as 100% SOC.

Test device B is fully discharged at a constant current rate and Cathode is removed from test device B and is separately tested which is considered as 0% SOC.

At 100% SOC, the oxidation product is further confirmed by X-ray diffraction (XRD), which demonstrated a type of beta, gamma Manganese Oxide with the birnessite structure and belong to the hexagonal crystal system. After discharging to 0% SOC state, the pattern of Manganese Oxide cannot be observed which further confirm the dissolution of Manganese Oxide.

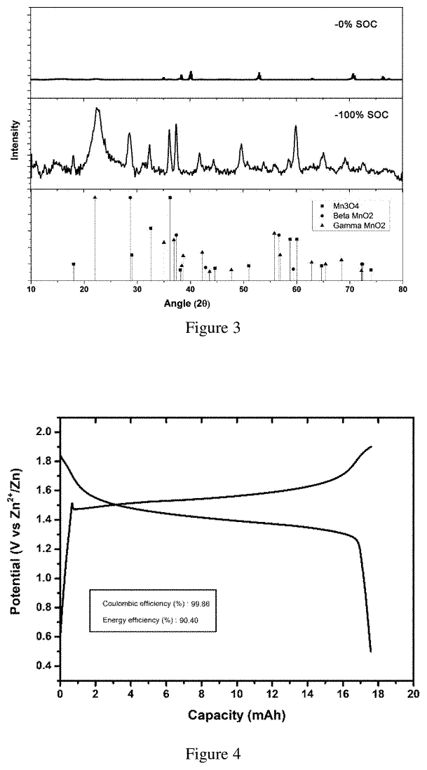

FIG. 3 shows XRD pattern of cathode of both test devices A and B at 100% and 0%, respectively, state of charge after removing carbon peaks. At 0% SOC there are no obvious peaks except for titanium current collector peaks while at 100% SOC there are Manganese Dioxide peaks.

Experiment 3

To determine Zinc Redox battery performance of a test device (1).

Test device (1) is prepared using the above method and tested using constant current charge and discharge techniques as described above.

Within the range of 0.5 to 1.9V, charge/discharge curves reveal a highly reversible electrochemical process. Low polarization is shown by the average charge and discharge voltage plateaus of 1.55 V and 1.4 V, respectively. The coulombic efficiency and energy efficiency of a highly reversible electrochemical reaction are both approximately >99% and >90%, respectively. FIG. 4 shows Galvanostatic charge-discharge profile of device. Two voltage plateaus at around 1.5 V and 1.4 V represents charging and discharging process, respectively.

Experiment 4

To determine the effect of constant cycling at lower C rate of C/5.

Test device (1) is prepared using the above method and tested using constant current techniques as described above.

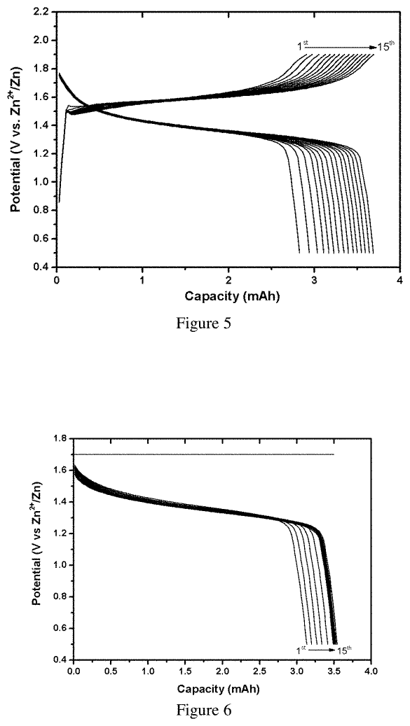

Test device (1) is tested by cycling under a voltage limit of 0.5 to 1.9 V to investigate the cycling stability at slow C rate of C/5. It shows that the capacity improves after each full cycle for the first 15 cycles. This indicates there is a more electrolyte utilization over prolonged cycling period. FIG. 5 shows cycling of a test device (1) at a constant current, the device's charge-discharge behavior. Both profiles show a steady increase in discharge capacity as the cycle life increases.

Experiment 5

To determine the effect of constant voltage charging on the Zinc Redox battery test device (1).

Test device (1) is prepared using the above method and tested using constant current techniques as described above.

During charging at a constant voltage of 1.7 V, soluble Mn²⁺ ions in the eutectic electrolyte is oxidized to Manganese Oxide deposited evenly on the carbon substrate, while simultaneous electrodeposition of Zn occurs on the anode. The voltage value of 1.7 V ensures both a successful electrodeposition reaction and the suppression of any other side reaction. Even with constant voltage charging methods the test device (1) is stable and has higher efficiency of 80%. FIG. 6 shows Galvanostatic charge-discharge profile of test device (1) at constant voltage 1.7 V charge—constant current discharge (CV-CC) condition.

Experiment 6

To determine the effect of C rating on Zinc Redox battery test device (1).

Test device (1) is prepared using the above method and tested using constant current charge and discharge techniques as described above.

Test device (1) is tested by cycling under a different C rating with voltage limit of 0.5 to 1.9V to investigate stability of test device (1) under higher load. Even at higher C rate of 5C it shows high energy efficiency of 82% indicating lower internal resistance of the test device (1).

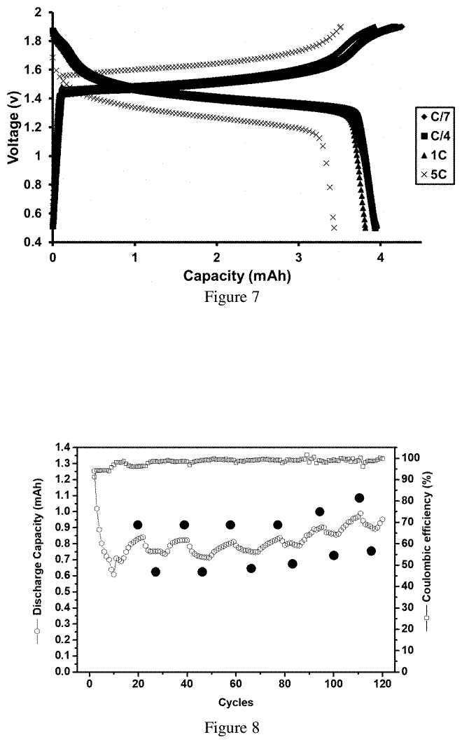

FIG. 7 shows Galvanostatic charge-discharge profile of device at different current rate, i.e., C/7, C/4, 1C, 5C. High columbic efficiency and low polarization is observed throughout the current range.

Experiment 7

To determine the effect of temperature on Zinc Redox battery test device (1) capacity.

Test device (1) is prepared using the above method and tested using constant current charge and discharge techniques as described above.

Test device (1) is tested by cycling under a different temperature rating of 15° C. and 30° C. It is observed that at higher temperature the capacity increases as compared to lower temperature. FIG. 8 shows the cycle performance—Coulombic efficiency and discharge capacity of prepared device in different temperature of 15° C. (Lower Dot) and 30° C. (Upper Dot).

Experiment 8

To determine the effect of prolong cycling at different C rates.

Test device (1) is prepared using the above method and tested using constant current techniques as described above.

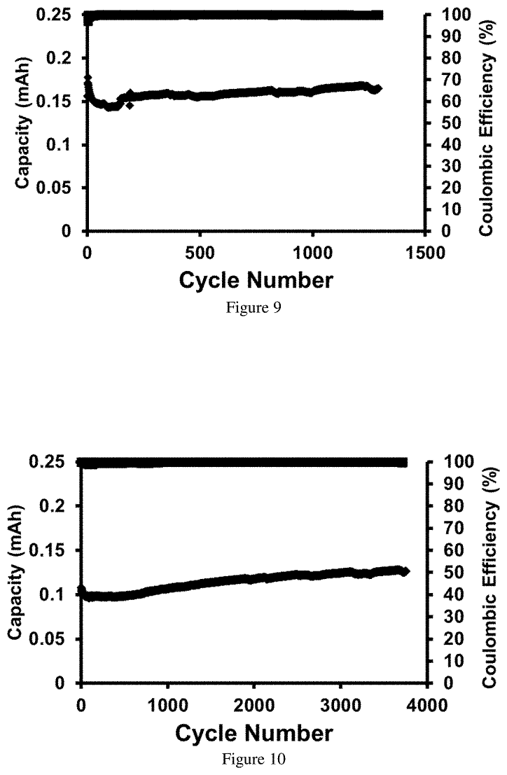

The device shows good cycling stability at 3C showing 95% capacity retentions even after 1300 cycles. The device with a higher rate capability of 5C shows a stable cycle life up to 3500 cycles. FIG. 9 shows Cycle life, Coulombic efficiency of the Zinc Redox battery at 3C rate. The Zinc Redox battery exhibits excellent cycling stability. Close to 95% of the maximum discharge capacity is maintained after prolong cycling. The Zinc Redox battery exhibits excellent cycling stability, even at high rates. FIG. 10 shows Cycle life, Coulombic efficiency of the Zinc Redox battery at 5C rate. The Zinc Redox battery exhibits excellent cycling stability, even at high rates.

Changes and modifications in the specifically-described embodiments may be carried out without departing from the principles of the present invention, which is intended to be limited only by the scope of the appended claims as interpreted according to the principles of patent law including the doctrine of equivalents.

1. A zinc based rechargeable redox static energy storage device comprising:
a cathode pre-infused with a eutectic electrolyte in ratio ranging between 0.5-1.5:2-5;
an anode pre-infused with the eutectic electrolyte in ratio ranging between 0.5-1.5:2-5;
a first current collector connected to the cathode;
a second current collector connected to the anode; and
a separator separating the cathode and anode, wherein the separator is configured so that an ion exchange carries in between the cathode and anode through ionic permeability.

2. The zinc based rechargeable redox static energy storage device of claim 1, wherein:
the cathode comprises a composition of a first carbon material and a first binder in weight ratio maintained between 80-99.9:0.1-20;
the anode comprises a composition of a second carbon material, a Zinc material, and a second binder in weight ratio maintained between 80-90:10-15.9:0.1-10;
wherein the first and second carbon materials are selected from the group consisting of conductive carbon black, graphite, carbon particles, carbon nanoparticles, woven or non-woven carbon cloth, carbon felt, carbon paper, carbon rod, and combination thereof;
wherein the first and second binders are selected from the group consisting of PTFE, PVDF, SBR, CMC, and PVA;
wherein the Zinc material is selected from the group consisting of Zinc powder, Zinc Dust, and Zinc foil;
wherein the eutectic electrolyte comprises one or more inorganic transition metal salt(s) of zinc selected from the group consisting of Zinc Chloride, Zinc Acetate, and Zinc Methanesulfonate, Zinc Sulphate, Zinc triflate;
one or more salt(s) of metal(s) selected from the group consisting of manganese, nickel, titanium and copper metal with sulphate anions, methane sulfonate anions, halides anions including chloride, bromide, and organic salts of transition metal ions with anions selected from the group consisting of acetate, oxalates, formates, phosphinates, lactate, malate, citrate, benzoate, and ascorbate;
one or more Metal hydroxide(s) selected from the group consisting of sodium hydroxide, potassium hydroxide, aluminum hydroxide, zinc hydroxide, calcium hydroxide, cesium hydroxide, magnesium hydroxide, and iron hydroxide;
wherein one or more inorganic transition metal salt(s) of zinc, one or more salt(s) of metal(s), and one or more Metal hydroxide(s) in molar concentration range 0.1-3:0.1-3:0.05-1 are mixed to a eutectic solvent comprising one or more derivative(s) of methanesulfonic acid selected from its salts with various metal ions selected from the group consisting of manganese, zinc, cerium, nickel, titanium, copper, sodium, potassium and calcium;
one or more ammonium salt(s) having general formula NH4X, where X is selected from the group consisting of chloride, methanesulfonate, acetate, sulphate, triflate, and trimethanesulfonate; and
one or more hydrogen bond donor(s) selected from the group consisting of urea, thiourea, glycerol, oxalic acid, acetic acid, ethylene glycol, acetamide, benzamide, adipic acid, benzoic acid, and citric acid;
wherein the molar ratio of derivative(s) of methanesulfonic acid, ammonium salt(s) and hydrogen bond donor(s) is in the range 0.5-3: 2-7:8-13.

3. The zinc based rechargeable redox static energy storage device of claim 2, wherein the first current collector is selected from the group consisting of titanium, and carbon material, and the second current collector is selected from the group consisting of titanium, carbon material, and zinc material.

4. The zinc based rechargeable redox static energy storage device of claim 3, wherein the separator comprises material selected from the group consisting of micro porous PVC, micro porous poly propylene, absorptive glass mat, and cellulose filter paper.

5. The zinc based rechargeable redox static energy storage device of claim 4, wherein the thickness ratio of the anode and cathode ranges in between 2-10:1-5.

6. The zinc based rechargeable redox static energy storage device of claim 5, having a C rating of 0.2-5.

7. The zinc based rechargeable redox static energy storage device of claim 6, having a cycle life ranging between 3000 to 10000 cycles.

8. A method of preparing a zinc based rechargeable redox static energy storage device, said method comprising:
infusing a cathode with a eutectic electrolyte in ratio ranging between 0.5-1.5:2-5;
infusing an anode with the eutectic electrolyte in ratio ranging between 0.5-1.5:2-5;
connecting a first current collector to the cathode;
connecting a second current collector connected to the anode; and
separating the cathode from the anode with a separator so that an ion exchange carries in between the cathode and the anode through ionic permeability.

9. The zinc based rechargeable redox static energy storage device of claim 1, wherein the first current collector is selected from the group consisting of titanium, and carbon material, and the second current collector is selected from the group consisting of titanium, carbon material, and zinc material.

10. The zinc based rechargeable redox static energy storage device of claim 9, wherein the separator comprises material selected from the group consisting of micro porous PVC, micro porous poly propylene, absorptive glass mat, and cellulose filter paper.

11. The zinc based rechargeable redox static energy storage device of claim 9, wherein the thickness ratio of the anode and cathode ranges in between 2-10:1-5.

12. The zinc based rechargeable redox static energy storage device of claim 9, having a C rating of 0.2-5.

13. The zinc based rechargeable redox static energy storage device of claim 9, having a cycle life ranging between 3000 to 10000 cycles.

14. The zinc based rechargeable redox static energy storage device of claim 1, wherein the separator comprises material selected from the group consisting of micro porous PVC, micro porous poly propylene, absorptive glass mat, and cellulose filter paper.

15. The zinc based rechargeable redox static energy storage device of claim 1, wherein the thickness ratio of the anode and cathode ranges in between 2-10:1-5.

16. The zinc based rechargeable redox static energy storage device of claim 1, having a C rating of 0.2-5.

17. The zinc based rechargeable redox static energy storage device of claim 1, having a cycle life ranging between 3000 to 10000 cycles.

18. The zinc based rechargeable redox static energy storage device of claim 17, wherein the separator comprises material selected from the group consisting of micro porous PVC, micro porous poly propylene, absorptive glass mat, and cellulose filter paper.

19. The zinc based rechargeable redox static energy storage device of claim 18, wherein the thickness ratio of the anode and cathode ranges in between 2-10:1-5.

20. The zinc based rechargeable redox static energy storage device of claim 19, having a C rating of 0.2-5.
